(19) United States
(12) Patent Application Publication
(10) Pub. No.: US 2010/0284036 A1
(43) Pub. Date: Nov. 11, 2010

(54) METHOD OF PROVIDING E-BOOK SERVICE AND SYSTEM THEREOF

(76) Inventors: Jong Sun Ahn, Seoul (KR); Jung-Suk Ahn, Seoul (KR)

Correspondence Address: MAIER & MAIER, PLLC, 1000 DUKE STREET, ALEXANDRIA, VA, 22314, US

(21) Appl. No.: 12/735,467

(22) PCT Filed: Jan. 16, 2009
(86) PCT No.: PCT/KR2009/000241

§ 371 Date: Jul. 19, 2010

(30) Foreign Application Priority Data
Jan. 17, 2008 (KR) 10-2008-0005400
Dec. 19, 2008 (KR) 10-2008-0129881

(51) Int. Cl. G06F 3/12

(52) U.S. Cl. 358/1.15

(57) ABSTRACT

A method of and a system for providing an e-book service are disclosed. More specifically, the method of providing an e-book service performed by an e-book server is provided by obtaining a printed document image generated according to a print command of a user for a virtual printer of a first user terminal, registering an e-book corresponding to the printed document image in an e-book database, obtaining a request for reading the e-book registered in the e-book database from a second user terminal, and responding to the request for reading the e-book by sending information on the e-book to the second user terminal. Accordingly, by using the virtual printer installed in the user terminal, a more efficient e-book service can be provided.

### TECHNICAL FIELD

The present invention is related to a method of providing an e-book service and a system of the e-book service.

### BACKGROUND ART

The Internet is so closely related to daily life that it is no longer possible to imagine a life without the Internet. The news media deliver the news in real time though their websites, and businesses are on line to be in touch with the consumers and collect the opinions from the consumers.

The Internet also plays the role of the media that share personal knowledge and information. The prevalence of personal devices, such as digital cameras, which assist the production of UCC (user created contents) also has accelerated the development of these new media.

With the stronger foundation of the Internet as the media, publications that used to be published with a physical form and available in offline bookstores have naturally been converted to and traded as a form of e-books on the Internet.

Nevertheless, creating and distributing e-books can be a quite cumbersome process for individual writers. Even for e-book service providers, providing e-book conversion means that can address a variety of file formats used by the writers is an important issue.

Moreover, both the writers and the e-book service provides require effective means for managing e-books that have been already converted and distributed, for their mutual benefit.

### DISCLOSURE

### Technical Problem

The present invention provides a method of and a system for providing an e-book service efficiently by using a virtual printer.

### Technical Solution

An aspect of the present invention provides a method of providing an e-book service performed by an e-book server that is provided by obtaining a printed document image generated according to a print command of a user for a virtual printer of a first user terminal, registering an e-book corresponding to the printed document image in an e-book database, obtaining a request for reading the e-book registered in the e-book database from a second user terminal, and responding to the request for reading the e-book by sending information on the e-book to the second user terminal. Accordingly, by using the virtual printer installed in the user terminal, a more efficient e-book service can be provided.

The printed document image can be generated based on spool data generated according to the print command for the virtual printer. The spool data can follow an Enhanced Metafile (EMF) format. The printed document image can be an image expressed by rendering the spool data following the EMF format, RAW format, etc.

In the obtaining of the request for reading the e-book, address information can be obtained through a web browser program of the second user terminal. In the responding to the request for reading the e-book, information on an e-book corresponding to the obtained address information can be sent to the second user terminal so that the e-book can be displayed by the web browser program.

The method can also include verifying validity of user authentication information from the first user terminal. The registering of the e-book in the e-book database can be performed if the obtained authentication information is valid.

The method can also include verifying validity of settlement information from the first user terminal, and the responding to the request for reading the e-book can be performed if the settlement information is valid. The settlement information from the first user terminal can be indirectly transferred as a result of verifying the validity through a separate settlement server.

The request for registration of the e-book can also include additional information in addition to the printed document image, and the additional information can include at least one of creator identification information, information on the type of registration of an e-book, information on the category of an e-book, information on distribution authorization, information on reading authorization and information on period for providing an e-book.

The method can also include providing a list of e-books posted by a same creator among e-books registered in the e-book database.

The method can be written in a program executed in a computer, and the program can be recorded in a computer-readable medium.

Another aspect of the invention provides a system for providing an e-book service, which includes: an e-book registration request obtaining unit configured to obtain a request for registration of an e-book from a first user terminal, the request for registration of the e-book including a printed document image generated according to a print command of a user for a virtual printer of the first user terminal; an e-book management unit configured to register an e-book corresponding to the printed document image in an e-book database; and an e-book providing unit configured to respond to a request for reading an e-book registered in the e-book database from a second user terminal.

The printed document image can be generated based on spool data generated according to the print command for the virtual printer. The spool data can follow an Enhanced Metafile (EMF) format.

The e-book providing unit can provide a list of e-books posted by a same creator among e-books registered in the e-book database.

Another aspect of the invention provides a method of providing an e-book service, which includes: recognizing a print job generated according to a print command of a user for a virtual printer installed in a terminal by monitoring the operation of the virtual printer; generating a printed document image corresponding to contents of a document that is an object of the print command; and requesting for registration of an e-book by sending a request for registration of the e-book including the printed document image.

In the generating of the printed document image, the printed document image can be generated based on spool data corresponding to the print job. The spool data can follow an Enhanced Metafile (EMF) format.

In the recognizing of the print job, the print job can be recognized by using a port monitor DLL involved in the operation of a virtual monitor installed in the terminal.

The request for registration of the e-book can also include additional information in addition to the printed document image, and the additional information can include at least one of creator identification information, information on the type of registration of an e-book, information on the category of an e-book, information on distribution authorization, information on reading authorization and information on period for providing an e-book.

The method can be written in a program executed in a computer, and the program can be recorded in a computer-readable medium.

Another aspect of the invention provides an e-book service support terminal, which includes: a printer monitoring module configured to recognize a print job processed according to a print command of a user for an installed virtual printer by monitoring the operation of the virtual printer; a printed document image generation module configured to generate a printed document image corresponding to a document that is a print object of the print job recognized by the printer monitoring module; a communication module configured to request for registration of an e-book by sending a request for registration of the e-book including the printed document image to an e-book server.

The printed document image generation module can generate the printed document image based on spool data corresponding to the print job. The spool data can follow an Enhanced Metafile (EMF) format.

The printer monitoring module can recognize the print job by using a port monitor DLL involved in the operation of a virtual printer installed in the terminal.

The e-book refers to a book provided in an electronic form, and can be understood as a group or package of electronic information that can be provided to a user through a terminal (PC, mobile phone, etc.). In an embodiment of the present invention, the e-book can include a printed document image itself generated using a virtual printer of a user terminal or another image converted from the printed document image. The term e-book can be interchangeably used with terms electronic document and electronic catalog.

Other aspects, features and advantages of the present invention will be apparent through the accompanying drawings, claims and mode for invention.

### DESCRIPTION OF DRAWINGS

FIG. 1 illustrates an environment in which a method of providing an e-book service in accordance with an embodiment of the present invention is realized.

FIG. 2 illustrates a process of printing a document with a first user terminal in accordance with an embodiment of the present invention.

FIG. 3 is a flow diagram of a method of providing an e-book service in accordance with an embodiment of the present invention.

FIG. 4 is a flow diagram of a method of providing an e-book service by a first user terminal in accordance with an embodiment of the present invention.

FIG. 5 is a flow diagram of a method of providing an e-book service by an e-book server in accordance with an embodiment of the present invention.

FIG. 6 illustrates the process status of a virtual printer installed in a terminal in accordance with an embodiment of the present invention.

FIG. 7 illustrates inputting the print command in accordance with an embodiment of the present invention.

FIG. 8 illustrates a user authentication information request screen in accordance with an embodiment of the present invention.

FIG. 9 illustrates a dialogue window for confirming the transmission of an e-book registration request in accordance with an embodiment of the present invention.

FIG. 10 illustrates a notification of completion of registration of an e-book in accordance with an embodiment of the present invention.

FIGS. 11 and 12 illustrate personalized pages provided in accordance with an embodiment of the present invention.

FIG. 13 illustrates an e-book displayed through a web browser program in accordance with an embodiment of the present invention.

FIGS. 14 to 16 illustrate a screen for reading an e-book in accordance with an embodiment of the present invention.

FIG. 17 illustrates a data structure of an e-book registration request in accordance with an embodiment of the present invention.

### MODE FOR INVENTION

Hereinafter, an embodiment of a method of providing an e-book service and a system thereof will be described in detail with reference to accompanying drawings. This, however, is not intended to limit the present invention to a particular mode of embodiment, shall be construed to include all modifications, equivalents and substitutes within the technical ideas and scopes of the present invention. In describing the present invention, certain detailed description of related art will not be provided when it is deemed such description may obscure the essence of the present invention. Moreover, in referring to the accompanying drawings, any identical or corresponding elements will be given same reference numerals, and any redundant description referring to the same reference numerals will be omitted.

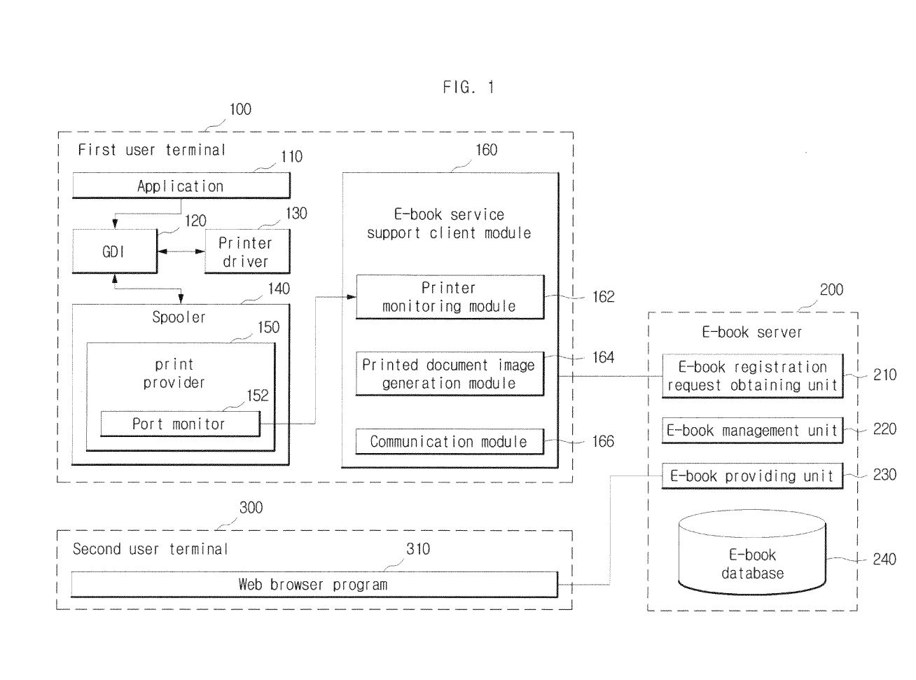

FIG. 1 illustrates an environment in which a method of provided an e-book service in accordance with an embodiment of the present invention is realized.

Illustrated in FIG. 1 is a data flow among a first user terminal 100, which is a terminal that requests the generation of an e-book, an e-book server 200, in which an e-book is registered and provided, and a second user terminal 300, which is a terminal that reads an e-book.

The first user terminal 100 is a terminal that requests the registration of a new e-book to the e-book server 200. In an embodiment of the present invention, a user can request the registration of an e-book to the e-book server 200 through a print command to a virtual printer installed in the first user terminal 100.

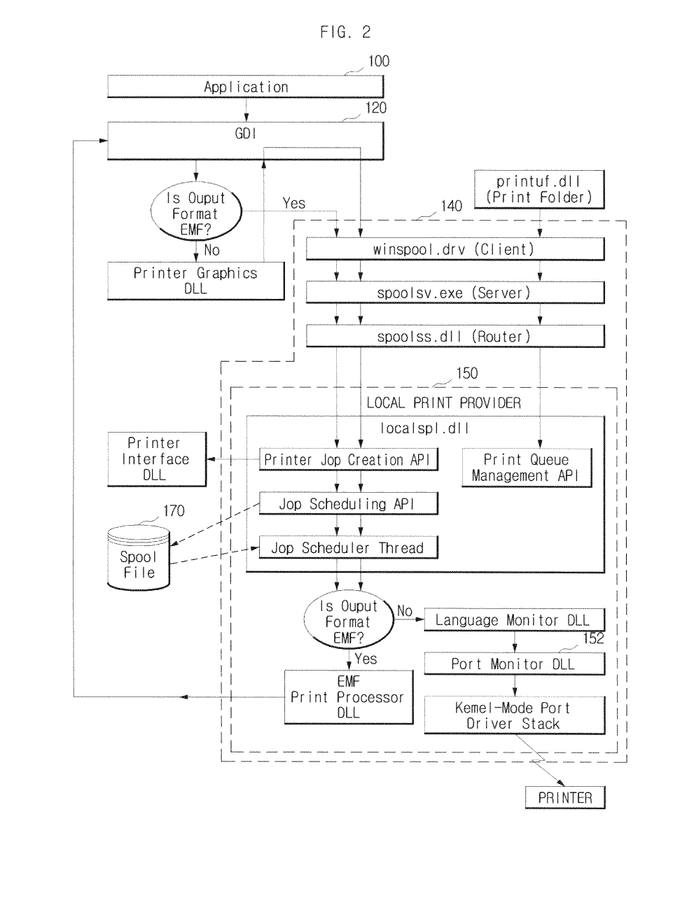

The print command by the user in accordance with an embodiment of the present invention can be carried out through exchange of information among an application 100, a GDI 120, a printer driver 130 and a spooler 140. A general print command process will be described in detail with reference to FIG. 2.

The e-book service using the first user terminal 100 is supported by an e-book service support client module 160 of the first user terminal 100. The e-book service support client module 160 can recognize a print job generated by a print command of the user and generate a printed document image reflecting the contents of a document that is the object of the print command. By transmitting the generated printed document image to the e-book server 200, the e-book service support client module 160 allows the e-book server 200 to register an e-book corresponding to the printed document image.

The above functions can be performed by a printer monitoring module 162, a printed document image generation module 164, and a communication module 166 included in the e-book service support client module 160.

The printer monitoring module 162 monitors the operation of the virtual printer installed in the first user terminal 100. Once the print job in accordance with the print command for the virtual printer supporting the e-book service is generated, spool data relating to the print job is generated. The printer monitoring module 162 detects the generation of the print job and/or the spool data relating to the print job, and initiates processes for registering the e-book. As such, the user can initiate a series of processes for registering an e-book by providing a print command for the virtual printer supporting the e-book service.

The print job can be recognized by the print monitoring module 162 by having a port monitor 152 of a print provider 150 transfer information on the print job to the printer monitoring module 162. In one example, the port monitor 152 can allow the print monitoring module 162 to obtain identification information of the spool data by transferring a message to the print monitoring module 162, in case a port corresponding to the virtual monitor is activated. The identification information (route information) of the spool data can be grasped through a registry, and can be obtained through a query about the operating system of the first user terminal 100. In another embodiment of the present invention, a port monitor 152 of a print provider 150 can transfer identification information including route information of spool data to a printer monitoring module 162.

The printed image generation module 164 can generate the printed document image based on the spool date, which is related to the print job generated by the print command of the user for the virtual printer. The spool data can include a spool file, of which the extension is SPL. The spool data can be created in the format of an EMF and RAW data.

The printed document image is image information that displays the contents of a document that is the print object of the virtual printer. The printed document image can be created in a format corresponding to a variety of extensions, including JPG and PNG. The created printed document image can be transferred to the e-book server 200. The printed document image transferred to the e-book server 200 can be provided as a response to a request of the second user terminal 300 for reading an e-book. The response to the request for reading an e-book can include modified image information based on the printed document image.

The communication module 166 performs exchange of information between the e-book service support client module 160 and the e-book server 200. Once the print command is made to the virtual printer by the first user terminal 100, the first user terminal 100 proceeds with follow-up processes corresponding to the print command and transmits a request for registration of an e-book based on the document, which is the print object of the virtual printer, to the e-book server 200.

The request for registration of an e-book from the first user terminal 100 can be an electronic signal created in accordance with a predetermined protocol for communication with the e-book server 200. The request for registration of an e-book can include information to be stored in an e-book database. In one example, the request for registration of an e-book can include the printed document image created by the printed document image generation module 164.

Moreover, the request for registration of an e-book can include additional information in addition to the printed document image. The additional information can include creator identification information, information on the type of registration of the e-book, information on the category of the e-book, information on distribution authorization, information on reading authorization and information on period for providing the e-book.

The printed document image and additional information can be transmitted in the form of a single package included in the request for registration of an e-book, and coding and decoding algorithms can be used for communication security between the communication module 166 and the e-book server 200.

The creator identification information is for identifying a creator who wants to register an e-book from the first user terminal 100. The creator identification information can include ID information assigned to a user who uses the e-book service. The creator identification information can be utilized while a list of e-books created by a same creator is prepared.

The information on the type of registration of the e-book is information on the type by which the e-book is to be registered. The e-book can be registered in a form that substitutes the conventional e-book or in a form of an independent, new e-book, according to what the information on the type of registration of the e-book indicates.

The information on the category of the e-book indicates the category in which the e-book belongs. The e-book can be classified according to the category indicated by the information on the category of the e-book, and providing a list of e-books classified by the category makes the management of the e-books easier.

The information on distribution authorization sets an authorization for distributing the e-book. In an embodiment of the present invention, it is possible to distribute the e-book by using the URL that is peculiar to each e-book, and thus setting the authorization for distributing the e-book using the information on distribution authorization can be an effective means for protecting the copyright of the creator.

The information on reading authorization sets an authorization for reading the e-book. While the e-book can be distributed to specified individuals, the e-book can be distributed to unspecified mass through URL information by which the e-book is accessible. Under this situation, setting the authorization for reading the e-book can be effective means for protecting the copyright of the creator.

The information on period for providing the e-book sets the period for which the e-book is provided. The creator can sets the period for which the e-book is provided when creating the e-book, and the e-book can be unavailable after the period.

The e-book server 200 is a system for managing the e-book for the purpose of providing the e-book service in accordance with an embodiment of the present invention. The e-book server 200 can include an e-book registration request obtaining unit 210, an e-book management unit 220 and an e-book providing unit 230.

The e-book registration request obtaining unit 210 obtains a registration request of an e-book from the first user terminal 100. The e-book registration request can include the printed document image and additional information. The obtained e-book registration request can be transferred to the e-book management unit 220 to be utilized as a basic reference for changing storage particulars of an e-book database 240.

The e-book management unit 220 manages the e-book database 240 to register, update and delete e-books.

A new e-book can be registered by registering a new e-book identification in the e-book database 240 and by, in case a request for reading an e-book corresponding to the identification is received, registering information to be provided in the e-book database 240. The registration of the e-book can be performed based on the request for registration of an e-book received by the e-book registration request obtaining unit 210 from the first user terminal. The printed document image obtained as a part of the request for registration of an e-book can be stored in the e-book database 240, and, if necessary, additional image processing can be made in the printed document image prior to the storing. The additional information in addition to the printed document image can be also stored in the e-book database.

The request for registration of an e-book made by the first user terminal 100 can include a request to change the contents of e-books that are managed by the e-book server 200, and the kind of registration request can be delivered as the information on the type of registration of the e-book, which is a part of the additional information.

The e-book providing unit 230 provides the information on e-books managed by the e-book server 200 to the second user terminal 300 to allow its user to read the contents of the e-books. The information on the e-book can be provided through a web service that is provided by the e-book server 200, and in this case, the e-book providing unit 230 can be defined as the part of the e-book server 200 that supports the daemon function, which handles the web service.

A request for reading an e-book can be transferred to the e-book server through a web browser program 310 of the second user terminal 300. The request for reading an e-book can include address information corresponding to the e-book.

The address information corresponding to the e-book can include a URL address indicating the e-book server 200, and include a parameter value for specifying an e-book managed by the e-book database 240 of the e-book server 200.

The second user terminal 300 is a terminal requesting to read an e-book to the e-book server 200.

An e-book can be read by the second user terminal 300 through the web browser program 310. The web browser program 310 is a program allowing the second user terminal 300 to read a document (an e-book) on the Internet through wire and/or wireless communication.

Once address information for the e-book to read is inputted in the second user terminal 300, the web browser program 310 transmits a request for reading the e-book to an e-book server 200 corresponding to the address information. The address information inputted in the web browser program 310 can include URL information indicating the e-book server 200 and a parameter value for specifying the e-book. The address information can be expressed in the form of a query for a web service daemon of the e-book server 200.

It is possible that a separate client program is installed for reading an e-book at the second user terminal 300, and such client program can be distributed in the form of a plug-in of the web browser program 310 of the second user terminal 300.

A mobile phone, PDA, PC, etc. can be used as the first user terminal 100 and second user terminal 300. Any device encompassing an input function for obtaining a command of the user and a communication function for transferring information with the e-book server 200 can be used as the first user terminal 100 and the second user terminal 300. If the second user terminal 300 is using a wireless Internet environment, such as WAP, ME, i-mode, etc., a browsing program that is appropriate for the wireless Internet environment can be utilized for reading the e-book.

FIG. 2 illustrates a process of printing a document with a first user terminal in accordance with an embodiment of the present invention.

Three major elements of the first user terminal 100 that are involved in the process of printing the document are an application program, a GDI and a spooler. The printer driver 130 is loaded in a process context of the application 100 or the spooler 140.

The application 100 is a program that is used to read or edit a document at the first user terminal. For example, the application 100 can be a word processor program, a web browser program, etc. installed in the first user terminal 100. In case there is a print command for a document read/edited by the application 100, the application 100 generates a print job by calling the GDI.

The GDI 120 translates a print request of the application to a device driver interface (DDI) call. In case the output format is an EMF, the GDI 120 spools to an SPL file. An EMF format can be utilized to form the spool data. The EMF format can be understood as the DDI calls tied together in order.

If spooled to a RAW format, the GDI 120 is directly called to a printer graphics DLL. Then, the rendered data is passed on to the spooler, and then passes through a language monitor DLL, a port monitor DLL, etc.

If spooled to an EMF format, the printer graphic DLL is not called first. In case the print job is completely spooled and playback is possible, a print processor will call back the GDI 120, which then calls the printer graphics DLL.

The printer driver 130 converts the DDI call of the printer to a print command to be sent to a printer device. However, the printer driver in accordance with an embodiment of the present invention is a driver of a virtual printer that does not have a physical hardware, and the conversion of the spool data to a printed document image can be carried out by the printed document image generation module 164.

The spooler 140 is a major element of a printing interface of the first user terminal 100. The spooler can be installed in the first user terminal as an executable file that manages a printing process.

In case the application 100 generates a printer device context (DC) in response to the print command of the user, the spooler can determine the location of a required printer driver and load the printer driver. The type of data writing the print job can be also determined by the spooler 140. The types of data supported for storing the print job include EMF, ASCII text and raw data. Moreover, the post script (PS), Macintosh PICT and PDF file formats can be also utilized in the spooling process.

The process of carrying out the print command of the user can be changed based on the operating system of the first user terminal 100. For example, if the operating system of the first user terminal is Windows Vista, the print job generated by the application 100 can call Windows Presentation Foundation (WPF) instead of GDI. Likewise, if the operating system is the Mac OS of Apple, the GDI described with reference to FIG. 2 can be substituted by QuickDraw or Quartz.

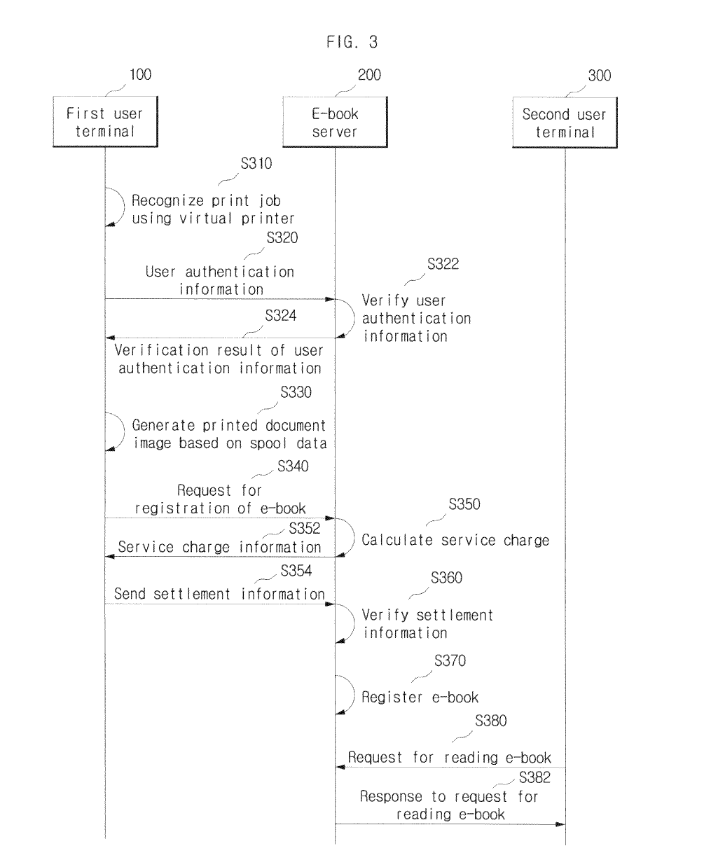

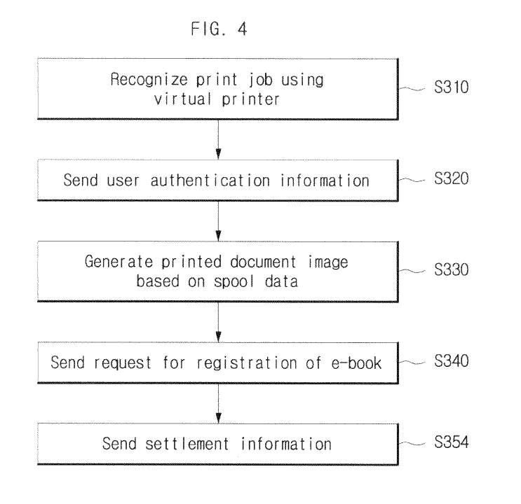

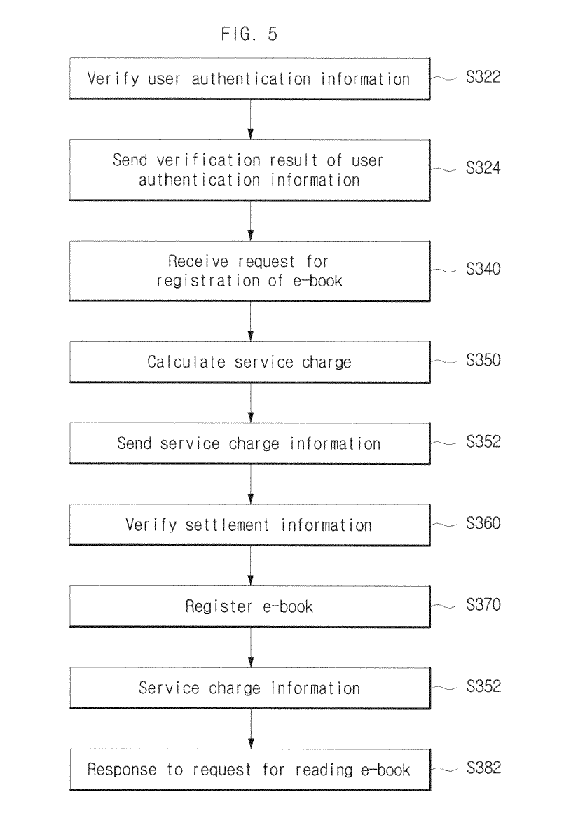

FIG. 3 is a flow diagram of a method of providing an e-book service in accordance with an embodiment of the present invention. FIG. 4 is a flow diagram of a method of providing an e-book service by a first user terminal in accordance with an embodiment of the present invention. FIG. 5 is a flow diagram of a method of providing an e-book service by an e-book server in accordance with an embodiment of the present invention.

In the step of recognizing a print job using a virtual printer (S310), the printer monitoring module 162 of the first user terminal recognizes the print job generated by a print command of a document using the virtual printer.

The process for registering an e-book can be started by recognizing the print job by the e-book support client module 160. Accordingly, the user can start a process for registering a new e-book or updating a pre-registered e-book, simply by giving the print command through the application 100.

User authentication can be required for proceeding with the process for the e-book service (the registration of an e-book) in accordance with an embodiment of the present invention. The user authentication for using the e-book service can include the step of the first user terminal 100 sending user authentication information to the e-book server 200 (S320), the step of the e-book server 200 verifying the user authentication information (S322) and the step of the e-book server 200 returning a verification result of the user authentication information (S324).

The user authentication information can include information such as a user ID, a password, etc. Moreover, an authentication server for user authentication can be also involved. In this case, the user authentication information from the first user terminal 100 can be transmitted to the authentication server, and the verification result of the user authentication information by the authentication server can be transmitted to the e-book server 200.

In the method of providing an e-book service, it is not necessary that the user authentication process is performed prior to the step of sending a request for registration of the e-book (S340). In case the user authentication is performed together with the step of sending a request for registration of the e-book (S340), the user authentication information from the first user terminal 100 can be included in and sent with the request for registration of the e-book. It is, of course, possible that the user authentication process is performed after the step of sending a request for registration of the e-book (S340).

In the step of generating a printed document image based on the spool data (S330), the printed document image generation module 164 of the first user terminal generates a printed document image based on the spool data generated while carrying out the print command at the first user terminal 100.

In an embodiment of the present invention, the spool data can be present in various forms, including a RAW format and an EMF format. By rendering such spool data, a printed document image corresponding to the information encompassed in the document, which is the object of printing. The printed document image can be transmitted to the e-book server 200 by being included in the request for registration of the e-book in order to be included as a part of the e-book, and it is also possible that additional image processing is given prior to being stored in the e-book database.

In the step of sending a request for registration of the e-book (S340), the e-book server 200 obtains a request for registration of the e-book sent by the first user terminal 100.

The request for registration of the e-book is a group of information transmitted to the e-book registration request obtaining unit 210 of the e-book server 200 from the communication module 166 of the first user terminal for the purpose of carrying out the print command using the virtual printer supporting the e-book at the first user terminal 100. The request for registration of the e-book can use a format defined in accordance with a predetermined protocol. As described earlier, the request for registration of the e-book can include a printed document image corresponding to the contents of the e-book as well as additional information.

A service charge settlement process can include the step of the e-book server 200 calculating a service charge (S350), the step of sending service charge information to the first user terminal (S352), the step of the first user terminal sending settlement information (S354) and the step of the e-book server verifying the settlement information (S360).

In the step of calculating a service charge (S350), the e-book server 200 calculates the cost for using the e-book service based on the additional information included in the request for registration of the e-book. The cost for using the e-book service can be calculated based on the additional information included in the request for registration of the e-book, and can consider the period for providing the e-book, which is included in the additional information, and information on authorization for reading the e-book as well as the amount of data in the printed document image.

In the step of sending service charge information to the first user terminal (S352), the calculated service cost information is sent to the first user terminal 100 so that the user who wants to register or update the e-book can check on the cost for the service being used.

In the step of sending settlement information (S354), the user of the first user terminal sends information for settling the cost for using the e-book service. The settlement information can be information on settlement means such as credit card information of the user. Moreover, password information for authorizing the settlement can be included in the settlement information.

In case a separate settlement server is involved, the settlement information from the first user terminal 100 can be transferred to the settlement server, which can transfer a result of verifying validity of the settlement information to the e-book server 200. In this case, the e-book server can indirectly verify the settlement information from the first user terminal 100 by receiving the result of verifying the settlement information transmitted by the separate settlement server.

Although the method of providing an e-book service illustrated in FIGS. 3 to 5 processes the service charge settlement process after the step of sending a request for registration of the e-book (S340), it is possible that the service charge settlement process is processed together with or prior to the step of sending a request for registration of the e-book (S340).

In the step of registering the e-book (S370), the e-book management unit 220 of the e-book server 200 manages information stored in the e-book database to register a new e-book or update the contents of a pre-registered e-book.

The e-book database 240 can store information to be provided as an e-book based on the printed document image and additional information obtained from the first user terminal. The e-book management unit 220 can manage the information stored in the e-book database 240 in response to the request for registration of the e-book from the first user terminal 100.

In the step of sending a request for reading the e-book to the e-book server, the second user terminal 300 requests for information on the e-book managed by the e-book server 200 by using, for example, the web browser program.

In the step of responding to the request for reading the e-book (S382), the e-book providing unit 230 returns to the second user terminal 300 with information on the e-book corresponding to the request for reading the e-book transmitted by the second user terminal 300.

The information returned by the e-book providing unit 230 can include the printed document image itself, which is generated by the first user terminal 100 and included in the e-book, or its converted image. Moreover, all or some of the additional information included in the request for registration of an e-book from the first user terminal 100 can be also sent as a part of the e-book to the second user terminal 300.

The e-book providing unit 230 in accordance with an embodiment of the present invention can provide a list of e-books that are arranged or grouped according to various criteria. A group of e-books can be created based on the additional information included in the request for registration of an e-book from the first user terminal 100. For example, e-books registered (posted) by a same user can from a group. In this case, the e-book server 200 can allow the user for easier reading by providing the second user terminal 300 with a list of hyperlinks for reading the e-books belonging to the group,

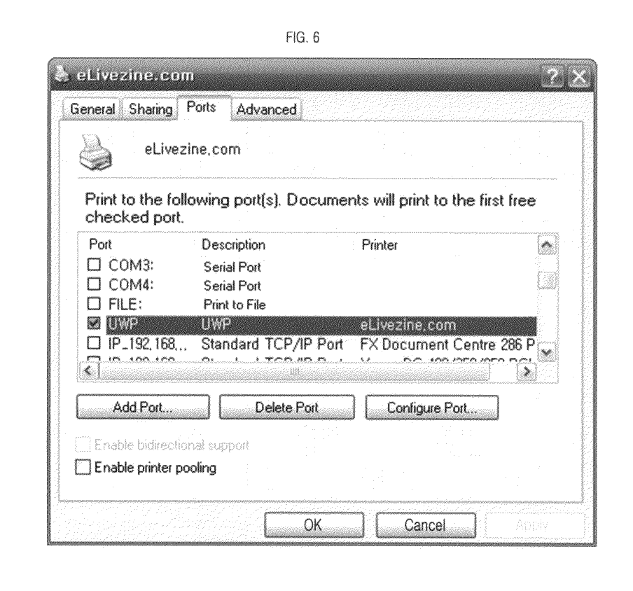

FIG. 6 illustrates the process status of a virtual printer installed in a terminal in accordance with an embodiment of the present invention.

Installed in the user terminal can be an e-book service support client module and a virtual printer for the use of the e-book service. Referring to FIG. 6, the name of the installed virtual printer is a domain (eLivezine.com) indicating a server provided by the e-book service. The port used by the virtual printer is named UWP. By monitoring the operation of the port, which is set for the virtual printer, at the user terminal, a print job associated with the virtual printer can be recognized.

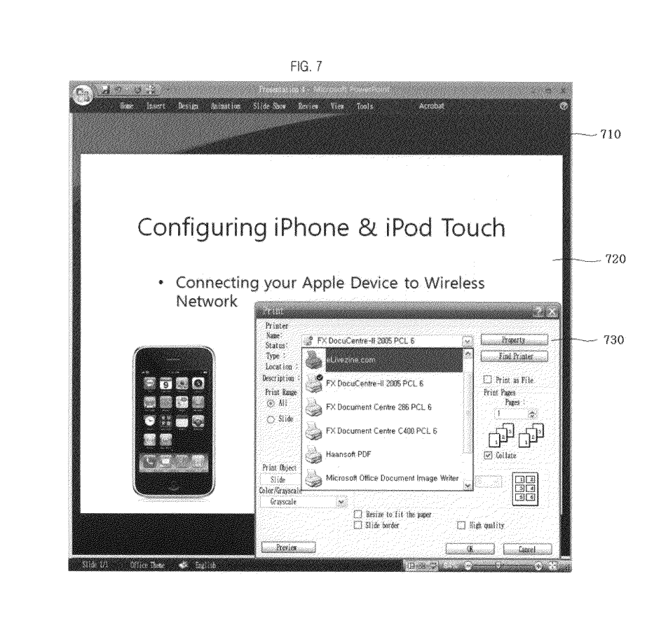

FIG. 7 illustrates inputting the print command in accordance with an embodiment of the present invention. Contents 720 of a document that is the object of the print command are displayed in an application window 710. The displayed contents 720 can be printed through a printer installed in the user terminal.

When the user selects the virtual printer (printer name: eLivezine.com) supporting the e-book service through a print window 730 for the registration of an e-book corresponding to the displayed contents 720 shown in FIG. 7, printing of the displayed contents through the virtual printer begins.

Spool data in accordance with the print command to the virtual printer can be converted to a printed document image corresponding to the displayed contents 720, and the printed document image can be a base material for the registration of the e-book. By using the virtual printer, the user can register the e-book, which is currently displayed through the application window 710. In other words, the WYSWYG (what you see is what you get) editing function can be provided through the virtual printer.

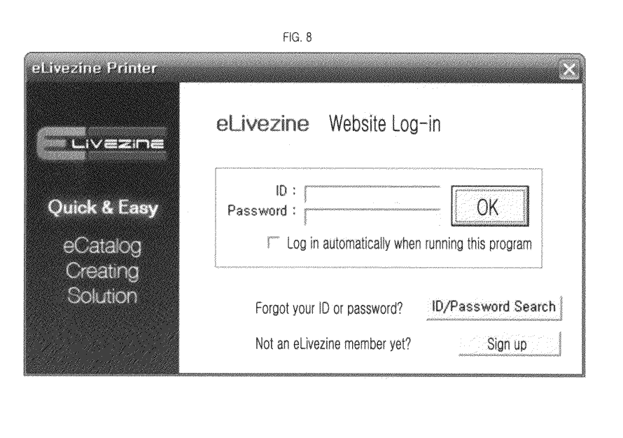

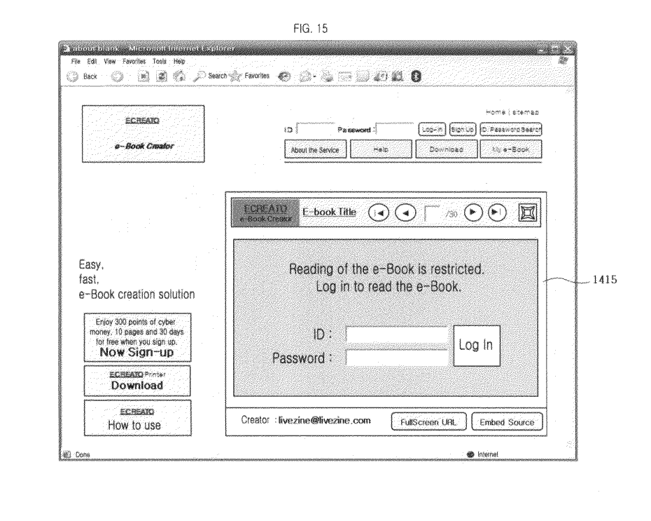

FIG. 8 illustrates a user authentication information request screen in accordance with an embodiment of the present invention. Prior to sending a request for registration of an e-book to the e-book server 200, a user ID and password can be inputted for user authentication. In another embodiment of the present invention, the user authentication can be requested for reading the e-book as well, which will be described with reference to FIG. 15.

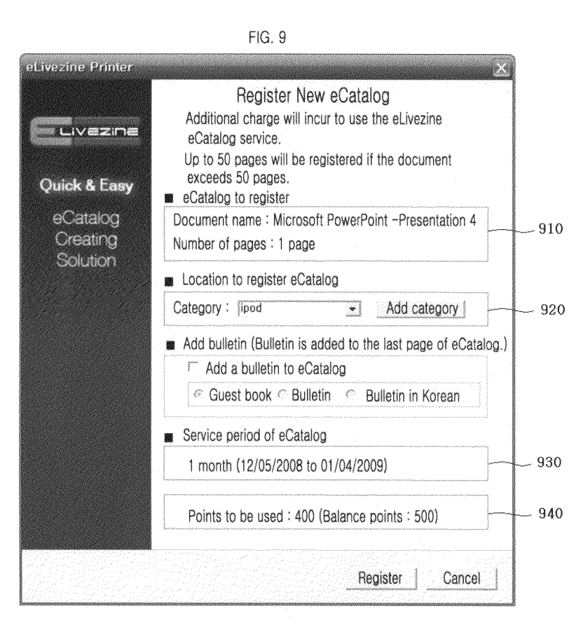

FIG. 9 illustrates a dialogue window for confirming the transmission of an e-book registration request in accordance with an embodiment of the present invention. Referring to FIG. 9, the additional information to be included in the request for registration of an e-book is displayed. Displayed are a name and number of pages of the e-book (eCatalog) 910, category information of the e-book 920, a period of the e-book service 930 and information on service charge 940.

In an embodiment of the present invention, the request for registration of an e-book can include category information of the e-book. This category information can be used to group e-books. The e-book registered in the e-book server 200 can be assigned with address information (URL information) to be used for reading the e-book, and the address information assigned to the e-book can be changed according to the category information.

The term “eCatalog” is a service name of an e-book and can be interchangeably used with the term “e-book.”

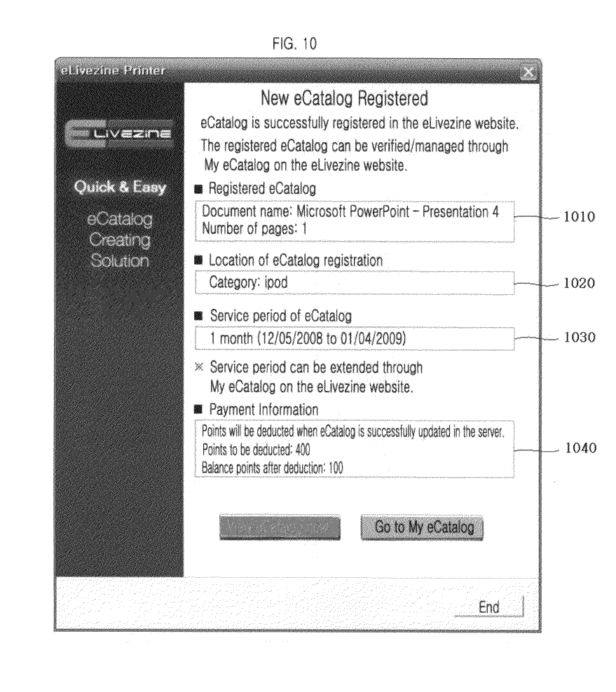

FIG. 10 illustrates a notification of completion of registration of an e-book in accordance with an embodiment of the present invention.

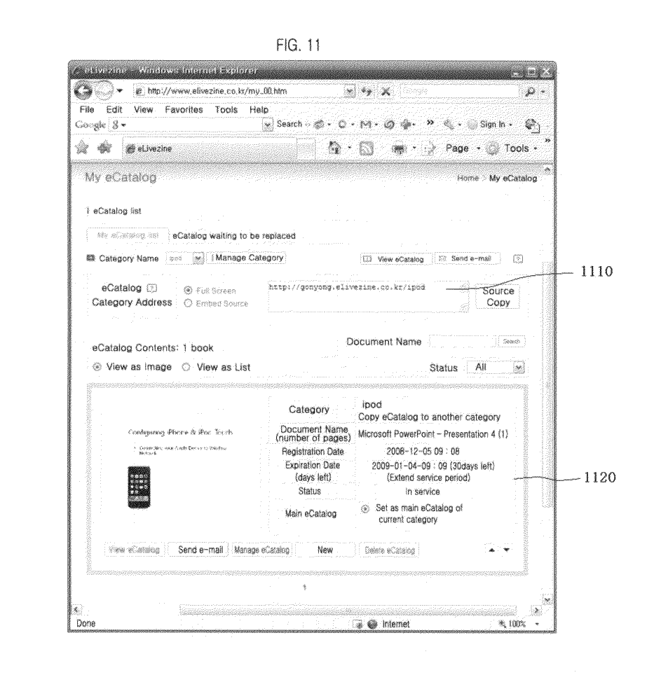

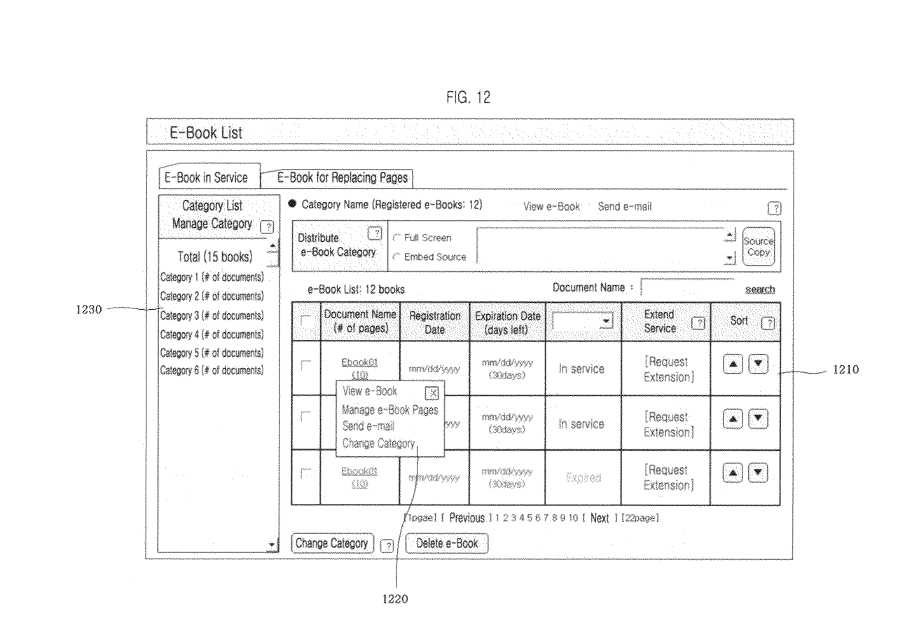

Referring to FIG. 10, illustrated are a name and number of pages of the e-book 1010, category information of the e-book 1020, a service (posing) period of the e-book 1030 and service charge information 1040. The “Go to My eCatalog” link on the lower side is a link for displaying a list of e-books posted by the user who posted the e-book, that is, a link for referencing a personalized page, which will be described with reference to FIGS. 11 and 12.

FIGS. 11 and 12 illustrate personalized pages provided in accordance with an embodiment of the present invention.

Referring to FIG. 11, displayed is a list of e-books posted by a same user and belonging to the category “ipod.” Address information (e.g., http://gonyong.elivezine.co.kr/ipod) is also assigned to the list of e-books belong to the same category. Each display item for the e-book in the list includes a thumbnail image and additional information 1120 for the registered e-book.

Referring to FIG. 12, the personalized page displays an e-book list display area 1210, an e-book management menu 1220 and a category group display area 1230.

The personalized page is a webpage displaying a list of e-books having the same creator. The creator can mange e-books created by him through the personalized page.

The e-book list display area 1210 provides a list of e-books posted by a same user. Referring to FIG. 12, displayed are a document name, registration date, service start date and a link for extending the service period.

The e-book service management menu 1220 displays links for executing commands for managing the e-book. Through this menu, the user can request the e-book server to show the e-book, manage the webpage providing the e-book, distribute the e-book through e-mail and change the category of the e-book.

In the category group display area 1230, a list of categories in which e-books belong is provided. When a link for each category is clicked, the e-book list display area 1210 is updated to display a list of e-books belonging to the category corresponding to the clicked link.

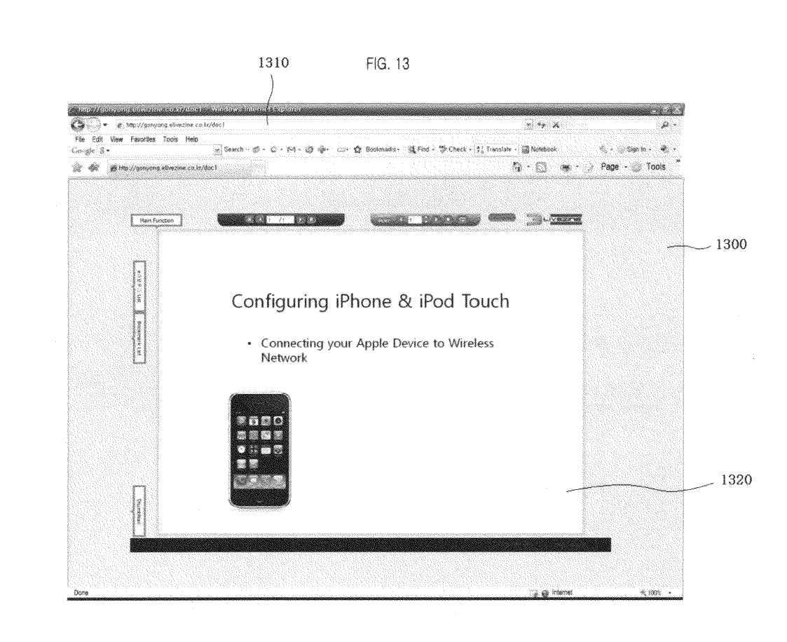

FIG. 13 illustrates an e-book displayed through a web browser program in accordance with an embodiment of the present invention.

When the registration of the e-book is completed by the e-book server 200, address information for accessing the e-book can be assigned. By inputting the address information in an address window 1310 of a web browser program 1300, the user can request to read the e-book.

Contents 1320 read in FIG. 13 corresponds to the contents 720 displayed in the application window 710 shown in FIG. 7. The e-book is registered based on the printed document image corresponding to the displayed contents 720, and information on the registered e-book includes the printed document itself or its converted image.

Address information for accessing the e-book is assigned. By using the address information assigned to the e-book, it becomes possible to distribute the e-book through, for example, e-mail. In one example, if an embed tag corresponding to the address information of the e-book is used in the text box of an e-mail message created in an HTML format, a recipient of the e-mail message can easily read the e-book.

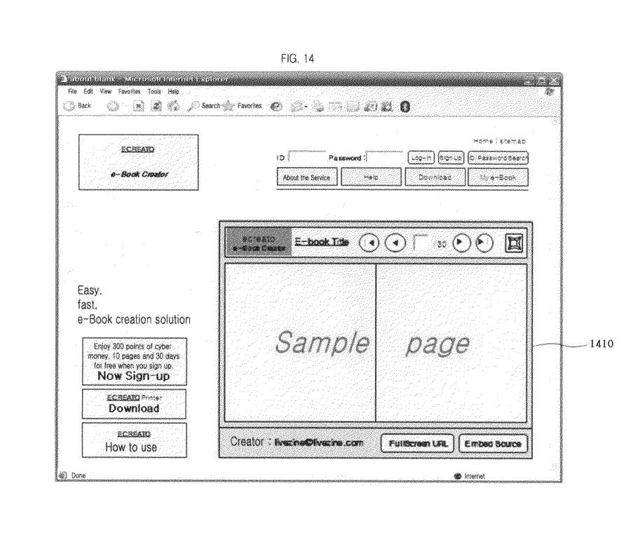

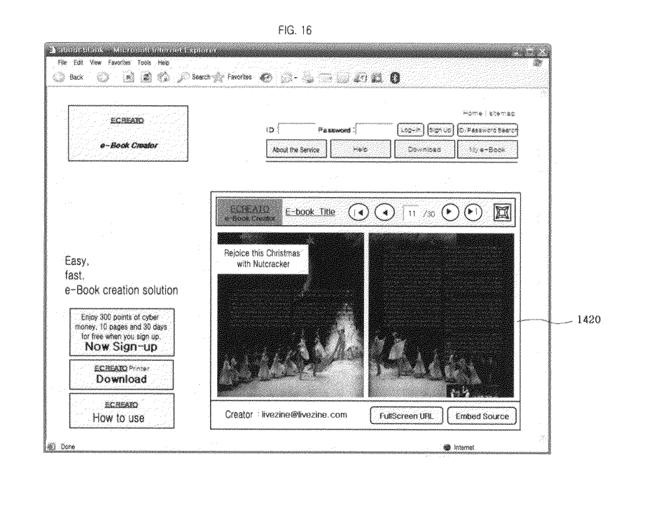

FIGS. 14 to 16 illustrate a screen for reading an e-book in accordance with an embodiment of the present invention. Referring to FIGS. 14 to 16, the e-book can be read through a web browser program. Contents of the e-book can be displayed as a part of a web page by using an embed tag.

By providing an input in the address window or clicking a link in the web browser program of the second user terminal 300, reading of information corresponding to the e-book of the e-book server 200 is requested. In case the authorization of the user who requested the reading is not verified, the e-book server 200 can provide a sample page 1410 of the e-book only to the second user terminal 300. If additional response information of the user for reading the pages is received, a screen 1415 requesting user authentication information, as shown in FIG. 15, can be displayed. When user authentication is successfully completed, contents 1420 in addition to the sample page can be provided to the second user terminal 300.

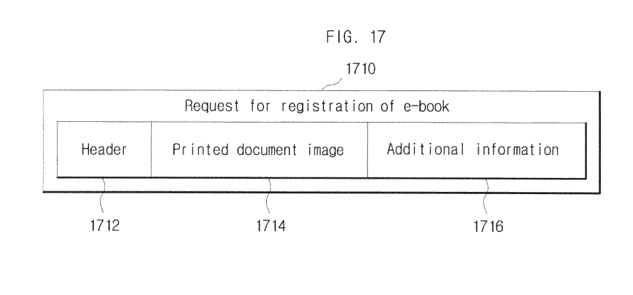

FIG. 17 illustrates a data structure of an e-book registration request in accordance with an embodiment of the present invention.

As described earlier, the printed document image generated as a result of carrying out a print command using the virtual printer of the first user terminal 100 can be transferred to the e-book server 200 by being included in a request for registration of an e-book 1710. The request for registration of an e-book can include a header 1712 in accordance with a predefined protocol. A command code that allows the e-book server 200 to start a process for registration of the e-book can be included in the header 1712.

A printed document image 1714 is information in which a print object document is converted to a form of an image. The printed document image 1714 can adopt various image formats, such as JPG and PNG. Additional information 1716 can include information on attributes of the e-book to be registered, in addition to the printed document image 1714.

It is not necessary that the request for registration of an e-book is constituted in the form of one package as illustrated in FIG. 17. It is also possible that the first user terminal 100 sends a command code for starting a process for registration of the e-book and sends a printed document image and/or additional information 1716 if and only if the e-book server 200 responds to the command code.

The method of providing an e-book service in accordance with an embodiment of the present invention can be provided in a computer program. The codes and code segments constituting the program can be easily contrived by a computer programmer skilled in the art. Moreover, the program can be stored in computer readable media that can be read by a computer, read by a computer and executed by a computer. The computer readable media include magnetic storage media, optical storage media and carrier wave media.

Terms such as “first” and “second” can be used to describe various elements, but the elements may not be restricted by these terms. These terms are only used to distinguish one element from another.

Elements illustrated in FIG. 1 are not necessarily embodied in hardware, and some elements can be embodied in an application program performing same or similar functions. It shall be also evident that the elements can be combined or separated within the scope of the technical ideas of the present invention.

Hitherto, the present invention has been described with reference to some embodiment. There can be many other embodiments in addition to the described embodiment within the claims of the present invention. It shall be understood by a person of ordinary skill in the art to which the present invention pertains that the present invention can be embodied in modified forms without departing from the essential features of the present invention. Therefore, the disclosed embodiment shall be understood in a descriptive perspective, not a restrictive perspective. The scope of the present invention is disclosed in the appended claims, not in the above description, and it shall be interpreted that all differences within the equivalent scope are included in the present invention.

### INDUSTRIAL APPLICABILITY

According to an embodiment of the present invention, a method of and a system for providing an e-book service that can provide more efficient and intuitive e-book registration and editing functions can be provided, by enabling a request for registration of an e-book to be sent to an e-book server through a print command to a virtual printer.

1. A method of providing an e-book service performed by an e-book server, the method comprising:
obtaining a printed document image generated according to a print command of a user for a virtual printer of a first user terminal;
registering an e-book corresponding to the printed document image in an e-book database;
obtaining a request for reading the e-book registered in the e-book database from a second user terminal; and
responding to the request for reading the e-book by sending information on the e-book to the second user terminal.

2. The method of claim 1, wherein the printed document image is generated based on spool data generated according to the print command for the virtual printer.

3. The method of claim 2, wherein the spool data follows an Enhanced Metafile (EMF) format.

4. The method of claim 1, wherein:
the obtaining of the request for reading the e-book includes obtaining address information through a web browser program of the second user terminal; and
the responding to the request for reading the e-book includes sending information on an e-book corresponding to the obtained address information to the second user terminal so that the e-book can be displayed by the web browser program.

5. The method of claim 1 further comprising verifying validity of user authentication information from the first user terminal, wherein the registering of the e-book in the e-book database is performed if the obtained authentication information is valid.

6. The method of claim 1 further comprising verifying validity of settlement information from the first user terminal, wherein the responding to the request for reading the e-book is performed if the settlement information is valid.

7. The method of claim 1, wherein:
the request for registration of the e-book further comprises additional information in addition to the printed document image; and
the additional information comprises at least one of creator identification information, information on the type of registration of an e-book, information on the category of an e-book, information on distribution authorization, information on reading authorization and information on period for providing an e-book.

8. The method of claim 1, further comprising providing a list of e-books posted by a same creator among e-books registered in the e-book database.

9. The method of claim 1, further comprising executing the method with a computer-readable medium.

10. A system for providing an e-book service, comprising:
an e-book registration request obtaining unit configured to obtain a request for registration of an e-book from a first user terminal, the request for registration of the e-book including a printed document image generated according to a print command of a user for a virtual printer of the first user terminal;
an e-book management unit configured to register an e-book corresponding to the printed document image in an e-book database; and
an e-book providing unit configured to respond to a request for reading an e-book registered in the e-book database from a second user terminal.

11. The system of claim 10, wherein the printed document image is generated based on spool data generated according to the print command for the virtual printer.

12. The system of claim 11, wherein the spool data follows an Enhanced Metafile (EMF) format.

13. The system of claim 10, wherein the e-book providing unit provides a list of e-books posted by a same creator among e-books registered in the e-book database.

14. A method of providing an e-book service, comprising:
recognizing a print job generated according to a print command of a user for a virtual printer installed in a terminal by monitoring the operation of the virtual printer;
generating a printed document image corresponding to contents of a document that is an object of the print command; and
requesting for registration of an e-book by sending a request for registration of the e-book including the printed document image.

15. The method of claim 14, wherein, in the generating of the printed document image, the printed document image is generated based on spool data corresponding to the print job.

16. The method of claim 15, wherein the spool data follows an Enhanced Metafile (EMF) format.

17. The method of claim 14, wherein, in the recognizing of the print job, the print job is recognized by using a port monitor DLL involved in the operation of a virtual monitor installed in the terminal.

18. The method of claim 14, wherein:
the request for registration of the e-book further comprises additional information in addition to the printed document image; and
the additional information comprises at least one of creator identification information, information on the type of registration of an e-book, information on the category of an e-book, information on distribution authorization, information on reading authorization and information on period for providing an e-book.

19. The method of claim 14, further comprising executing the method on a computer-readable medium.

20. An e-book service support terminal comprising:
a printer monitoring module configured to recognize a print job processed according to a print command of a user for an installed virtual printer by monitoring the operation of the virtual printer;
a printed document image generation module configured to generate a printed document image corresponding to a document that is a print object of the print job recognized by the printer monitoring module;
a communication module configured to request for registration of an e-book by sending a request for registration of the e-book including the printed document image to an e-book server.

21. The terminal of claim 20, wherein the printed document image generation module is configured to generate the printed document image based on spool data corresponding to the print job.

22. The terminal of claim 21, wherein the spool data follows an Enhanced Metafile (EMF) format.

23. The terminal of claim 20, wherein the printer monitoring module recognizes the print job by using a port monitor DLL involved in the operation of a virtual printer installed in the terminal.
